(19) United States
(12) Patent Application Publication
(10) Pub. No.: US 2010/0092826 A1
(43) Pub. Date: Apr. 15, 2010

(54) FUEL CELL AND FUEL CELL SYSTEM

(75) Inventors: Haruyuki Nakanishi, Susono-shi (JP); Yusuke Kuzushima, Kyoto-shi (JP); Norihiko Nakamura, Susono-shi (JP); Shinichi Matsumoto, Fuji-shi (JP); Hidekazu Arikawa, Susono-shi (JP); Kazuya Uchisasai, Susono-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 12/449,330

(22) PCT Filed: Feb. 7, 2008
(86) PCT No.: PCT/IB2008/000269

§ 371 Date: Dec. 18, 2009

(30) Foreign Application Priority Data
Feb. 8, 2007 (JP) 2007-029598
Dec. 13, 2007 (JP) 2007-322402

(51) Int. Cl. H01M 8/10; H01M 8/08

(52) U.S. Cl. 429/30; 429/34

(57) ABSTRACT

A fuel cell has an electrolyte, an anode provided on one side of the electrolyte and a cathode provided on the other side of the electrolyte, and a fuel passage which is formed so as to contact the anode and through which fuel flows. A substance having an ion-conducting property is mixed in with the fuel that flows through the fuel passage. For example, fuel is supplied to the fuel passage from a fuel supply apparatus, while a substance having an ion-conducting property is supplied to the fuel passage from an ion-conducting substance supply apparatus.

### BACKGROUND OF THE INVENTION

1. Field of the Invention

The invention relates to a fuel cell and a fuel cell system. More particularly, the invention relates to a fuel cell that generates power by an electrochemical reaction between fuel supplied to one electrode and oxygen supplied to another electrode, as well as to a fuel cell system that uses that fuel cell.

2. Description of the Related Art

There are currently many types of fuel cells, including alkaline fuel cells, phosphoric-acid fuel cells, molten carbonate fuel cells, solid-oxide fuel cells, and polymer electrolyte fuel cells. For example, Japanese Patent Application Publication No. 2002-8706 (JP-A-2002-8706) describes an alkaline fuel cell.

This alkaline fuel cell has an oxygen electrode, a hydrogen electrode, and a matrix that is sandwiched in between two electrodes. The matrix is a nonconducting membrane that has been impregnated with a prescribed potassium hydroxide solution. This fuel cell has a reaction chamber that contacts the hydrogen electrode. Hydrogen produced within the reaction chamber is supplied to the hydrogen electrode, and air is supplied to the oxygen electrode.

When hydrogen or air is supplied to the respective electrodes, at the oxygen electrode, an oxygen molecule acquires the electrons that have been stripped away from the hydrogen electrode and reacts with water. Then after several different stages, hydroxide ions are produced. These hydroxide ions travel through the prescribed potassium hydroxide solution to the hydrogen electrode. Meanwhile, at the hydrogen electrode, hydrogen gas is adsorbed to the catalyst electrode such that the hydrogen atoms are stripped away. These hydrogen atoms react with the hydroxide ions, and as a result, water is produced at the hydrogen electrode and electrons are released.

Also, according to the fuel cell of the related art described above, the hydrogen that is supplied to the hydrogen electrode does not contain carbon because it was produced in the reaction chamber. Being able to supply pure hydrogen that does not contain any carbon in this way prevents a decrease in the characteristics of the fuel cell that would otherwise occur due to the change in the properties of the electrolyte.

However, in the foregoing related art, the fuel that is supplied is limited to the pure hydrogen that is produced in the reaction chamber. Therefore, the total output of the fuel cell is ultimately limited by the amount of pure hydrogen that is produced in the reaction chamber. Typically, an alkaline fuel cell operates extremely well at low temperatures and is highly efficient at generating power in an operating range of 100° C. or less. However, considering the various environments in which fuel cells will be used in the future, it is desirable to further increase the total output and improve the output density and output efficiency of fuel cells. This is true for not only alkaline fuel cells, but other types of fuel cells as well.

### SUMMARY OF THE INVENTION

This invention thus provides an improved fuel cell and fuel cell system that improves the power generation performance by maintaining a proper three-phase boundary at an anode of a fuel cell.

A first aspect of the invention relates to a fuel cell that is provided with an electrolyte, an anode provided on one side of the electrolyte and a cathode provided on the other side of the electrolyte, and a fuel passage which is formed so as to contact the anode and through which fuel flows. Further, a substance having an ion-conducting property is mixed in with the fuel.

Accordingly, a substance having an ion-conducting property can be freshly supplied to portions where there is no electrolyte of the anode present or areas in which the electrolyte has flowed out or deteriorated. As a result, the three-phase boundary of the anode can be kept in the proper state so that the area of the reaction field is always large, which enables power generation efficiency to be improved.

In the foregoing aspect, the substance having the ion-conducting property may include the same substance as the substance of which the electrolyte is made.

Accordingly, electrolyte can be supplied to portions where there is no three-phase boundary in the anode or portions where the electrolyte of the three-phase boundary has deteriorated, thus enabling the three-phase boundary to be properly formed and maintained.

Also in the foregoing structure, the electrolyte may include an electrolyte solution that conducts anions.

Also in the foregoing structure, the electrolyte may be an anion exchange membrane.

That is, these structures can be applied to an alkaline fuel cell, and the three-phase boundary of the anode of the alkaline fuel cell can be reliably maintained, which enables power generation efficiency to be improved.

Further, in the foregoing structure, the substance having the ion-conducting property may be one selected from among the group consisting of potassium hydroxide and sodium hydroxide.

Accordingly, electrolyte can be supplied to portions where there is no three-phase boundary or portions where the three-phase boundary has deteriorated in the anode of an alkaline fuel cell, thus enabling the three-phase boundary to be properly formed and maintained, which improves the power generation performance of the fuel cell.

Also in the foregoing structure, the substance having the ion-conducting property may be triethanolamine.

Accordingly, electrolyte can be supplied to portions where there is no three-phase boundary or portions where the three-phase boundary has deteriorated in the anode of an alkaline fuel cell, thus enabling the three-phase boundary to be properly formed and maintained, which improves the power generation performance of the fuel cell.

Also in the foregoing structure, the fuel may be one selected from the group consisting of alcohol, methane, ammonium, and hydrogen.

When such a fuel is used, a three-phase boundary is more reliably formed, thereby sufficiently ensuring the area of the reaction field, which enables the power generation performance to be improved even more.

Also in the foregoing structure, the fuel may be one selected from among the group consisting of methanol and ethanol.

When such a fuel is used, a three-phase boundary is more reliably formed, thereby sufficiently ensuring the area of the reaction field. At the same time, these fuels are liquid fuels so ion-conducting substance can easily be mixed in with them, thus enabling the power generation performance to be improved even more.

Also in the foregoing structure, a percent of the substance having the ion conductive property with respect to the fuel may be greater than 0 and equal to or less than 20%.

Maintaining the percentage of ion-conducting substance within this range enables the three-phase boundary to be reliably maintained or formed, as well as ensures the necessary amount of fuel for the generation of power. Accordingly, the power generation performance of the fuel cell can be improved.

A second aspect of the invention relates to a fuel cell system that uses the fuel cell according to any one of the foregoing structures. This fuel cell system is provided with a fuel supply apparatus and an ion-conducting substance supply apparatus. The fuel supply apparatus supplies fuel to the fuel passage. The ion-conducting substance supply apparatus supplies a substance having an ion-conducting property together with the fuel.

Accordingly, even if the substance having the ion-conducting property that is supplied together with the fuel flows out or deteriorates such that the three-phase boundary is unable to be maintained, fresh ion-conducting substance can be supplied. Therefore, the three-phase boundary can be properly maintained which keeps the area of the reaction field large. As a result, the power generation performance of the fuel cell can be improved.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a view showing a frame format of a fuel cell according to one example embodiment of the invention;

FIG. 2 is a view showing an enlarged frame format of a portion of the fuel cell according to the example embodiment the invention;

FIG. 3 is a graph showing the current density of a fuel cell according to a first example (Example 1) of the example embodiment of the invention;

FIG. 4 is a graph showing the current density, voltage, and output density of a fuel cell according to a second example (Example 2) of the example embodiment of the invention;

FIG. 5 is a graph showing the current density, voltage, and output density of a fuel cell according to a third example (Example 3) of the example embodiment of the invention;

FIG. 6 is a graph showing the current density of a fuel cell according to a fourth example (Example 4) of the example embodiment of the invention;

FIG. 7 is a graph showing the current density, voltage, and output density of a fuel cell according to a fifth example (Example 5) of the example embodiment of the invention;

FIG. 8 is a chart showing the results of measurements of the voltage [V] and current density [mA/cm²] in each case when the amount of KOH mixed in with the ethanol was changed in Example 1;

FIG. 9 is a chart showing the results of measurements of the voltage [V] and current density [mA/cm²] in each case when the amount of KOH mixed in with the ethanol was changed in Example 4; and

FIG. 10 is a view showing a frame format of a modified example of the fuel cell according to the example embodiment of the invention.

### DETAILED DESCRIPTION OF THE EMBODIMENTS

Hereinafter, example embodiments of the invention will be described in detail with reference to the accompanying drawings. In the drawings, the same or corresponding parts will be denoted by the same reference numerals. Detailed descriptions of those parts will be simplified or omitted.

### Example Embodiment

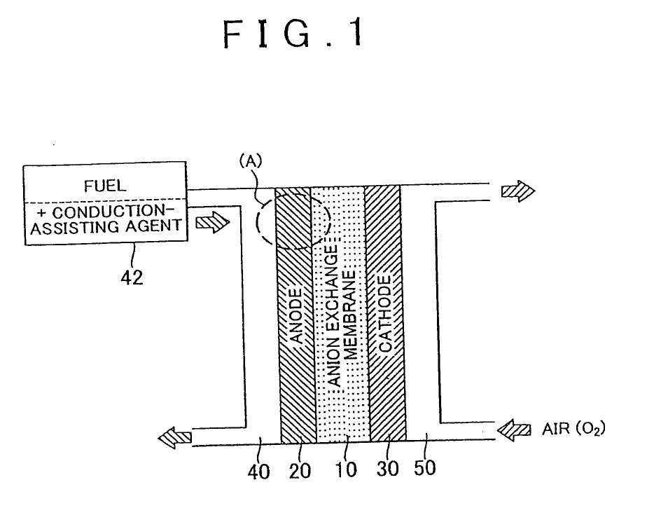

FIG. 1 is a view showing the structure of a fuel cell according to one example embodiment of the invention. The fuel cell shown in FIG. 1 is an alkaline fuel cell. The fuel cell has an anion exchange membrane 10 (electrolyte). An anode 20 is arranged on one side of the anion exchange membrane 10 and a cathode 30 is arranged on the other side of the anion exchange membrane 10. A fuel passage 40 is connected to the anode 20, and a fuel supply source 42 (i.e., a fuel supply apparatus and an ion-conducting substance supply apparatus) is connected to the fuel passage 40. Fuel is supplied from the fuel supply source 42 to the anode 20 through the fuel passage 40, and unreacted fuel is discharged from the anode 20. Meanwhile, an oxygen passage 50 is connected to the cathode 30. Air is supplied to the cathode 30 through the oxygen passage 50, and air-off gas that contains unreacted oxygen is discharged from the cathode 30.

When generating power in the fuel cell, fuel that contains at least hydrogen as the fuel is supplied to the anode 20, while air (or oxygen) is supplied to the cathode 30. When fuel is supplied to the anode 20, an anode catalyst layer, which will be described later, causes the hydrogen atoms in the fuel to react with hydroxide ions that have passed through the anion exchange membrane 10. As a result, water is produced and electrons are released. This reaction at the anode 20 is as shown in Expression (1) below and may hereinafter also be referred to as the anode reaction.

H₂+2OH⁻→2H₂O+2e⁻ (1)

Meanwhile, when air is supplied to the cathode 30, a cathode catalyst layer, which will be described later, causes oxygen molecules in the air to go through several stages where they acquire electrons from the electrode. As a result, hydroxide ions are produced. This reaction at the cathode 30 is as shown in Expression (2) below and may hereinafter also be referred to as the cathode reaction.

½O₂+H₂O+2e⁻→2OH⁻ (2)

When the anode reaction and the cathode reaction are put together, a water-producing reaction such as that shown in Expression (3) below takes place in the overall fuel cell. The electrons at this time travel through collector plates on both electrode sides, and as a result, current flows and power is generated.

H₂+½O₂→H₂O (3)

In this kind of alkaline fuel cell, the anion exchange membrane 10 is not particularly limited as long as it is a medium that transports hydroxide ions (OH⁻) produced at the catalyst electrode of the cathode 30 to the anode 20. More specifically, the anode exchange membrane 10 may be, for example, a solid polymer membrane (i.e., anion exchange resin) having an anion exchange group such as a primary, secondary, or tertiary amine group, a quaternary ammonium group, a pyridyl group, an imidazole group, a quaternary pyridinium group, and a quaternary imidazolium group. Also, the membrane of the solid polymer may be, for example, a hydrocarbon system or a fluorine system resin.

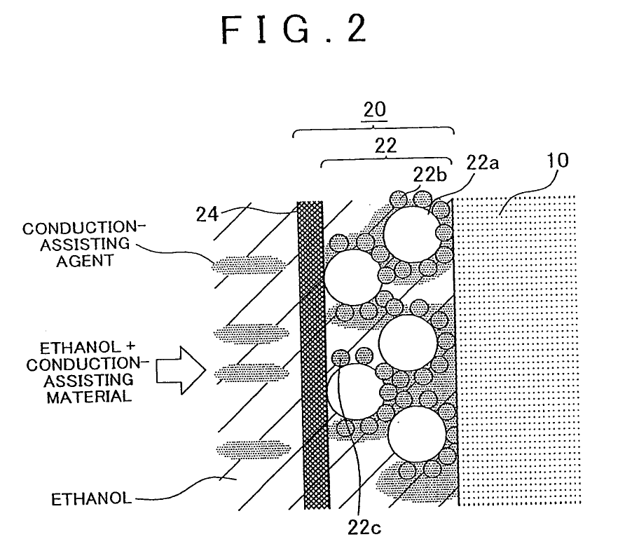

FIG. 2 is an enlarged view of the portion encircled by the dotted line (A) in FIG. 1. As shown in FIG. 2, the anode 20 has an anode catalyst layer 22 and a collector plate 24. Fuel supplied to the anode 20 passes through the collector plate 24 and is supplied to the entire surface of the anode catalyst layer 22. The anode catalyst layer 22 functions as a catalyst that strips the hydrogen atoms from the fuel that is supplied and reacts them with hydroxide ions that have passed through the anion exchange membrane 10, thereby producing water, and discharges the electrons (e) to the collector plate 24.

Similarly, the cathode 30 has a cathode catalyst layer and a collector plate, neither of which is shown. Air that is supplied to the cathode 30 passes through the collector plate and is supplied to the entire cathode catalyst layer. The cathode catalyst layer acquires electrons (e⁻) from the collector plate and produces hydroxide ions from the oxygen (O₂) and the water (H₂O).

The constituent material of the electrode catalysts is not particularly limited as long as it has the foregoing function. For example, the constituent material of the electrode catalysts may be material made of iron (Fe), platinum (Pt), cobalt (Co), or nickel (Ni), or material in which any one of those metals is carried on a carrier such as carbon, or a organometallic complex having these metal atoms as a central metal, or material in which such an organometallic complex is carried on a carrier. Also, a diffusion layer made of porous material or the like may also be arranged on the surface of the electrode catalysts.

The anode catalyst layer 22 shown in FIG. 2 will be described as one such example. As shown in FIG. 2, the anode catalyst layer 22 was formed by mixing a carrier 22a carrying catalyst particles 22b and 22c which are metal catalysts with an electrolyte having the same composition as the anion exchange membrane 10, and applying that mixture to the surface of the anion exchange membrane 10.

During the electrochemical reaction in the fuel cell, the hydroxide ions that have passed through the anion exchange membrane 10 travel through the electrolyte in the anode catalyst layer 22 until they reach the catalyst particles 22b. Meanwhile, when the fuel that was supplied is adsorbed to the catalyst particles 22b, it decomposes, producing hydrogen atoms. In the catalyst particles 22b, a reaction such as that shown in Expression (1) above takes place between these hydrogen atoms and the hydroxide ions.

However, this kind of electrochemical reaction takes place when a proper three-phase boundary is formed in which the electrolyte (or anion exchange membrane), the catalyst particles 22b, and the fuel are all present in the anode catalyst layer 22. For example, if there is no electrolyte around the catalyst particles, as is the case with the catalyst particle 22c in FIG. 2, the hydroxide ions are not able to reach that catalyst particle 22c. As a result, the catalyst particle 22c is unable to function as a reaction field and thus remains unused. That is, even if the catalyst particle 22c is present, a reaction can not take place at portions where a proper three-phase boundary has not formed. Accordingly, in order to further improve the power generation performance of the fuel cell, it is desirable to reduce the number of catalyst particles 22c that do not function as reaction fields and thus increase the area of the proper three-phase boundary (i.e., the reaction field area).

Therefore, in the fuel cell according to this example embodiment, a substance having an ion-conducting property (hereinafter this substance will be referred to as “conduction-assisting agent”) is mixed with fuel in the fuel supply source 42, and the fuel that contains this conduction-assisting agent is supplied. That is, a substance that has the same function as the anion exchange membrane 10, which is the electrolyte membrane, is supplied together with the fuel to the anode catalyst layer 22. Accordingly, the conduction-assisting agent and the fuel are supplied to the catalyst particles 22b and 22c. As a result, conduction-assisting agent is supplied as fresh electrolyte to portions where there is no electrolyte present or portions such as the catalyst particles 22c where a three-phase boundary is no longer able to be maintained due to outflow or deterioration of the electrolyte. Thus, a proper three-phase boundary can be formed at a large number of the catalyst particles 22b and 22c, thereby increasing the reaction field area in the anode 20.

More specifically, the substance having the ion-conducting property that is mixed in with the fuel need only have the ability to transport hydroxide ions through the anode catalyst layer 22, i.e., need only be able to make the anode catalyst layer 22 an alkaline atmosphere. Accordingly, for example, the conduction-assisting agent may be a solution of potassium hydroxide or sodium hydroxide or the like, or may be the same substance as the substance of which the anion exchange membrane 10 is made.

This kind of conduction-assisting agent need only be supplied to the anode 20 by being channeled through the fuel passage 40 together with the fuel. As a result, fresh electrolyte can be constantly supplied to portions where no three-phase boundary has formed or portions where the three-phase boundary has deteriorated. Accordingly, the three-phase boundary can be properly maintained, thereby keeping the reaction field area large. As a result, the power generation performance of the fuel cell can be kept high.

The fuel is not particularly limited as long as it contains hydrogen and the hydrogen atoms can be extracted at the anode 20. Accordingly, for example, alcohol, bioalcohol, or methane or ammonium or the like may be used. The alcohol may be methanol, ethanol, or bioethanol or the like. However, because the conduction-assisting agent is supplied mixed in with fuel, it is preferable that it be liquid at room temperature, like ethanol is. Also, ethanol can be obtained relatively inexpensively which makes it effective for also reducing the cost of the fuel cell.

Incidentally, in this example embodiment, the fuel cell used is an alkaline fuel cell having an anion exchange membrane 10. However, the invention is not limited to an alkaline fuel cell. For example, the invention may also be applied to a fuel cell in which a solid polymer membrane that conducts protons, such as a PEM, is used as an ion exchange membrane. In this case, protons travel through the membrane to the cathode side so the substance that conducts protons is mixed in with the fuel.

Also, in FIG. 1, the fuel cell is structured such that the anion exchange membrane 10 is sandwiched between a pair of electrodes (i.e., the anode 20 and the cathode 30), and the fuel passage 40 and the air passage 50 are provided for each of the electrodes. However, the invention is not limited to a fuel cell with this structure. For example, the fuel cell may be such that a plurality of membrane electrode assemblies (MEAs), each consisting of an electrolyte and a pair of electrodes, are stacked together separated by a separator. In this case as well, a proper three-phase boundary can be formed at the anode of each MEA if fuel containing a conduction-assisting agent is supplied to the passage that supplies fuel to the anode of each MEA.

Further, in the foregoing example embodiment, unreacted fuel is discharged from the anode 20. However, the invention is not particularly limited to this. For example, as shown in FIG. 10, a circulation passage 44 that is connected to the upstream side of the fuel passage may be connected to a conduit (downstream of the fuel passage 40) to which unreacted fuel is discharged, and the unreacted fuel can be circulated and used together with freshly supplied fuel and conduction-assisting agent.

Also, when the circulation passage 44 is provided in this way, if the conduction-assisting agent is an agent that does not degrade easily, conduction-assisting agent does not have to be freshly added to the fuel that is supplied from the fuel supply source 42. In this case as well, mixing the conduction-assisting agent in with the fuel that is circulated through the fuel passage in advance enables the conduction-assisting agent to be repeatedly supplied. Accordingly, the three-phase boundary can be properly maintained even if the conduction-assisting agent is not always supplied with the fuel. Also in this case, by taking into account the timing and the like of the degradation of the conduction-assisting agent, conduction-assisting agent can be mixed in with the fuel and freshly supplied from the fuel supply source 42 only at a predetermined timing.

Several examples of the example embodiment will now be described.

### Example 1

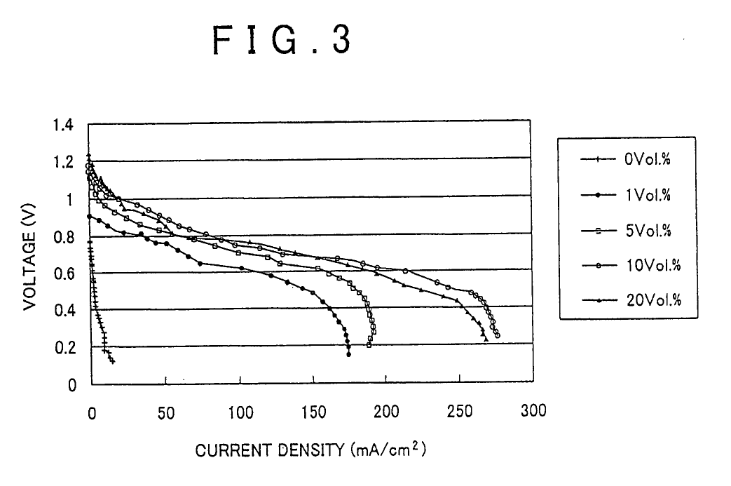

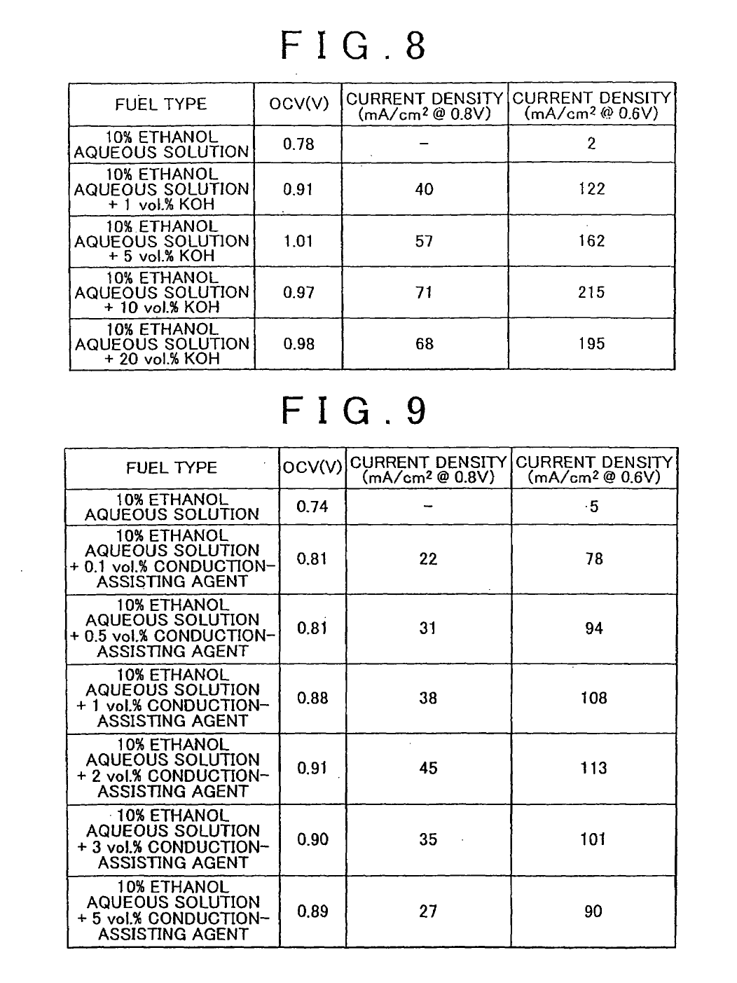

In Example 1, an MEA was manufactured as follows. An anion exchange membrane was used as the electrolyte membrane, and the electrode area was made to be 36 mm×36 mm. A Fe—Co catalyst carried on carbon was applied directly to the electrolyte membrane on the cathode side and a Fe—Ni—Co catalyst carried on Ni was applied directly to the electrolyte membrane on the anode side. Also, 10% ethanol aqueous solution was used as the fuel. KOH as the conduction-assisting agent was mixed in with this ethanol aqueous solution. In this example, the amount of KOH that was mixed in with the ethanol aqueous solution was changed to various percents between 0 and 20 percent [Vol. %]. The results after measuring the voltage [V] and current density [mA/cm²] in each case are shown in FIG. 8. These results are also shown in FIG. 3. In FIG. 3, the horizontal axis represents the current density [mA/cm²] and the vertical axis represents the voltage [V].

As shown in FIGS. 8 and 3, the current density when KOH was not mixed in was measured to be 2 [mA/cm²] at a voltage of 0.6 [V]. In contrast, in all cases in which the conduction-assisting agent was mixed in with the ethanol and that mixture fraction was between 1 and 20 [Vol. %], the current density significantly increased. Also, the current density was highest, at 215 [mA/cm²] at 0.6 [V] and 71 [mA/cm²] at 0.8 [V], and the best power generation efficiency was achieved when the amount of KOH that was mixed in was 10 [Vol. %].

In this way, it was confirmed that the current density is able to be increased even when the conduction-assisting agent is mixed in with the fuel. This is thought to be due to the fact that by supplying a substance having an ion-conducting property that transports anions, similar to the anion exchange membrane, a three-phase boundary formed by the catalyst particles, the fuel, and the electrolyte is properly formed such that more catalyst particles 22b and 22c are able to function as catalyst electrodes (i.e., reaction fields).

Incidentally, KOH tends to degrade when it reacts with the carbon (or carbon monoxide or carbon dioxide) in the fuel while in the fuel passage. Accordingly, when KOH is mixed in with ethanol, as in Example 1, it is likely unable to perform the necessary function due to its degradation, even if the conduction-assisting agent is circulated and used. Accordingly, when using KOH or another such conduction-assisting agent that is not very resistant to carbon, it is preferable to always discharge unreacted fuel instead of circulating the fuel and the conduction-assisting agent, or circulate and use unreacted fuel after first selectively separating out and extracting just the conduction-assisting agent from the unreacted fuel on the discharge side.

### Example 2

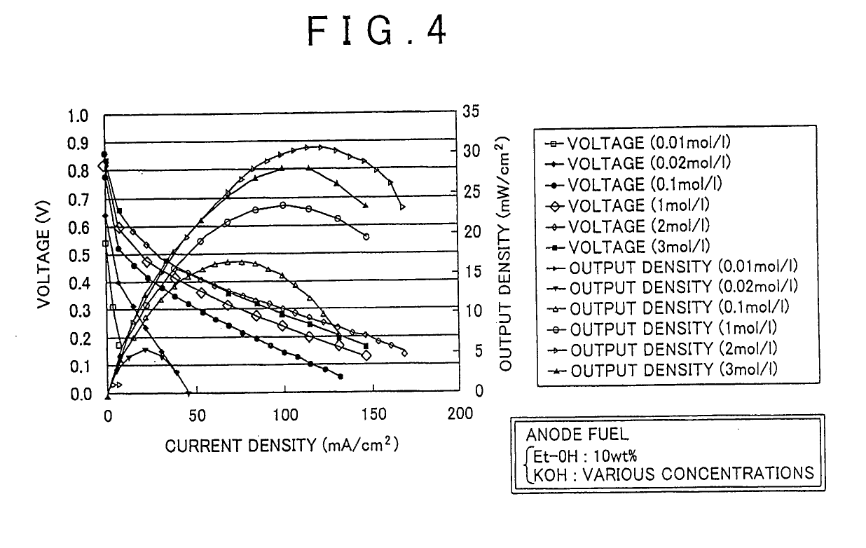

In Example 2, an MEA similar to the MEA in Example 1 was manufactured as follows. An anion exchange membrane was used as the electrolyte membrane, and the electrode area was made to be 36 mm×36 mm. A Fe—Co catalyst carried on carbon was used on the cathode side and a Fe—Ni—Co catalyst carried on Ni was used on the anode side. Also, 10% ethanol aqueous solution was used as the fuel to be supplied to the MEA. KOH was used as the conduction-assisting agent that was mixed in with the ethanol aqueous solution. In Example 2, the amount of KOH with respect to the entire mixture of KOH and ethanol aqueous solution that was mixed in with ethanol was changed to various percents between 0.01 and 3 [mol/l]. The voltage [V], output density [mw/cm²], and current density [mA/cm²] in each case were then measured. The results are shown in the graph in FIG. 4. In FIG. 4, the horizontal axis represents the current density [mA/cm²], the vertical axis on the left represents the voltage [V], and the vertical axis on the right represents the output density [mw/cm²].

As shown in FIG. 4, when the concentration of the KOH solution that is mixed in is low at 0.01 [mol/1], both the voltage [V] and the output density [mw/cm²] with respect to the current density [mA/cm²] are low. When the concentration of KOH is equal to or less than 2 [mol/1], both the voltage [V] and the output density [mw/cm²] increase as the concentration of KOH increases. Also, more specifically, high voltage [V] and high output density [mw/cm²] are obtained when the concentration of KOH is equal to or greater than 0.1 [mol/1], and the highest voltage [V] and the highest output density [mw/cm²] are obtained, as is the best power generation efficiency, when the KOH concentration is 2 [mol/l].

That is, from FIG. 4 it is evident that high output efficiency is unable to be obtained if there is either too little or too much KOH, i.e., electrolyte. This is thought to be because when there is too little KOH, high output is not obtained because there is an insufficient amount of conductor for the anions to travel through, and too much KOH inhibits the reaction with the fuel. Accordingly, in order to further improve power generation efficiency, it is preferable to mix in the electrolyte of an amount that compensates for any insufficiency in the amount of conductor but not so much that it inhibits the reaction.

### Example 3

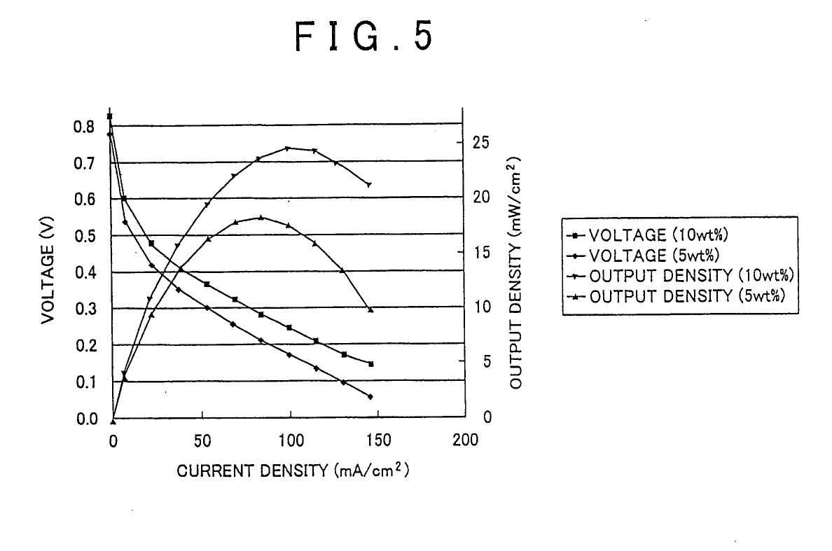

In Example 3, an MEA similar to the MEA in Example 1 was manufactured as follows. An anion exchange membrane was used as the electrolyte membrane, and the electrode area was made to be 36 mm×36 mm. A Fe—Co catalyst carried on carbon was used on the cathode side and a Fe—Ni—Co catalyst carried on Ni was used on the anode side. Also, ethanol aqueous solution was used as the fuel to be supplied to the MEA. KOH was used as the conduction-assisting agent that was mixed in with the fuel. The concentration of KOH is preferably 5 to 20 [wt %], so in Example 3 the concentration of KOH that was mixed in with the ethanol aqueous solution with respect to the entire mixture of KOH and ethanol aqueous solution was approximately 10 [wt %]. In Example 3, the voltage [V], the output density [mw/cm²], and the current density [mA/cm²] where measured when the concentration of the ethanol aqueous solution was 10 [wt %] and when it was 5 [wt %]. The results are shown in FIG. 5. In FIG. 5, the horizontal axis represents the current density [mA/cm²], the vertical axis on the left represents the voltage [V], and the vertical axis on the right represents the output density [mw/cm²].

From FIG. 5, it is evident that both the voltage [V] and the output density [mw/cm²] are higher with a high ethanol concentration of 10 [wt %] than they are when a low ethanol concentration of 5 [wt %]. This is thought to be because when there is not enough ethanol, there is a shortage of fuel so output decreases. On the other hand, when the ethanol concentration is too high, the percentage of water decreases, resulting in fewer reaction fields. Alternately, the electrolyte membrane swells, resulting in the change in the properties of the electrolyte membrane and a catalyst. Therefore it can be predicted that output will fall. Accordingly, in order to increase the power generation efficiency of the fuel cell, it is desirable to supply ethanol at the optimum concentration that ensures a certain amount of reaction fields, but which also will not result in a shortage of fuel, or the change in the preferable properties of the electrolyte membrane and a catalyst. The concentration of ethanol aqueous solution is preferably approximately 5 to 20 [wt %].

### Example 4

In Example 4, 10 [wt %]ethanol aqueous solution was used as the fuel, and a membrane having the same composition as the anion exchange membrane 10 was mixed in as the conduction-assisting agent with the ethanol aqueous solution. An anion exchange membrane, which is a solid polymer membrane, was dissolved in ethanol.

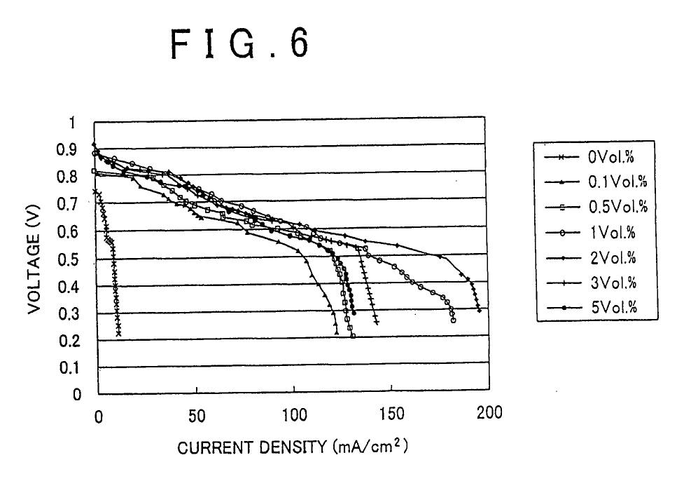

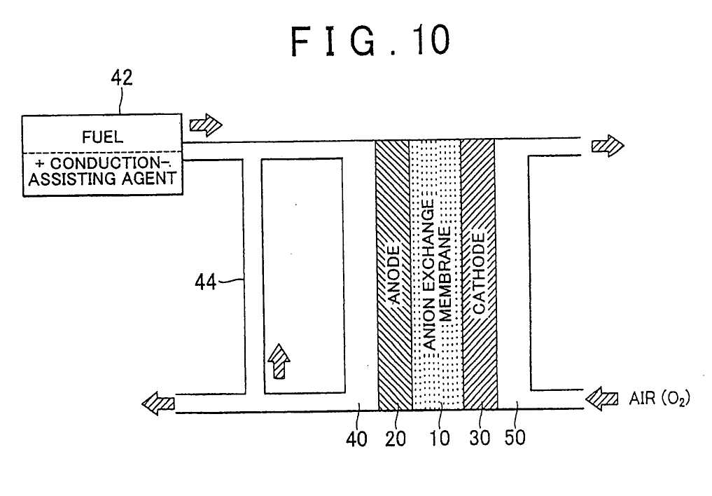

FIG. 9 shows the results obtained for the voltage [V] and the current density [mA/cm²] for each case when the amount of conduction-assisting agent that was mixed in with the ethanol was changed to various percents between 0 and 5 percent [Vol. %]. The term “Conduction-assisting agent” listed in the chart is the anion exchange membrane that was dissolved in the ethanol. The results are shown also in the graph in FIG. 6. In FIG. 6, the horizontal axis represents the current density [mA/cm²] and the vertical axis represents the voltage [V].

As shown in FIGS. 9 and 6, the current density when the conduction-assisting agent was not mixed in with the ethanol was measured to be 5 [mA/cm²] at a voltage of 0.6 [V]. In contrast, in all cases in which the conduction-assisting agent was mixed in with the ethanol and that mixture fraction was between 0 and 5 [Vol. %], the current density significantly increased. Also, the highest current density, at 113 [mA/cm²] at 0.6 [V] and 45 [mA/cm²] at 0.8 [V], is obtained, as is and the best power generation efficiency, when the amount of conduction-assisting agent that is mixed in is 2 [Vol. %].

In this way, it was confirmed that the current density is able to be increased even when the conduction-assisting agent is mixed in with the fuel. This is thought to be due to the fact that by supplying a conduction-assisting agent having the same composition as the anion exchange membrane 10, the three-phase boundary formed by the catalyst particles, the fuel, and the electrolyte is properly maintained such that more catalyst particles 22b and 22c are able to function as catalyst electrodes (i.e., reaction fields).

Also, the anion exchange membrane 10 is a substance that resists being poisoned by carbon. That is, when a conduction-assisting agent that is the same as the anion exchange membrane 10 is used, even if fuel containing carbon, such as ethanol, is used, poisoning of the conduction-assisting agent can be avoided. When an alcohol fuel or bioalcohol fuel or the like that contains carbon is used as the fuel and unreacted fuel is circulated by the circulation passage 44 and used as it is, it is preferable to mix in a conduction-assisting agent that is highly resistant to carbon, as in Example 2.

Further, in the invention, the anion exchange membrane 10 and the conduction-assisting agent in the fuel cell do not have to be of the same substance, as they are in Example 4. That is, the conduction-assisting agent may be of a different substance than the anion exchange membrane 10, i.e., another exchange membrane that functions like the anion exchange membrane may be used as the conduction-assisting agent.

### Example 5

In Example 5, 10 [wt %]ethanol aqueous solution was used as the fuel and triethanolamine (C₆H₁₅NO₃) solution which is written out in Chemical formula 1 below is used instead of KOH as the conduction-assisting agent in the ethanol aqueous solution.

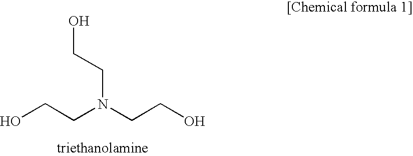

Triethanolamine functions as a conduction-assisting agent that conducts hydroxide ions OH⁻. In the anion exchange membrane 10, triethanolamine may also be used as an anion-exchange group. More specifically, in Example 5, triethanolamine was added so that its concentration was 10 [wt %] of the entire mixture of ethanol aqueous solution and triethanolamine.

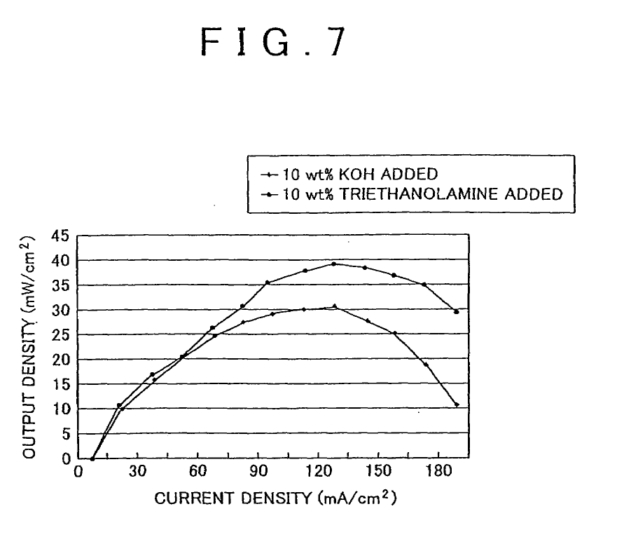

FIG. 7 shows the results from measuring the output density [mw/cm²] with respect to the current density [mA/cm²] when KOH was supplied mixed at a concentration of 10 [wt %] and when triethanolamine was mixed at a concentration of 10 [wt %]. Also, in FIG. 7, the curve plotted by the black squares represents the case when KOH was used, and the curve plotted by the black circles represents the case when triethanolamine was used. Further, in FIG. 7, the horizontal axis represents the current density [mA/cm²] and the vertical axis represents the output density [mw/cm²]. Also, the measurements were taken at room temperature and air was supplied as the oxidant to the cathode.

From FIG. 7, upon comparing the cases in which the same concentrations of KOH and triethanolamine were mixed in, it is evident that an overall higher output density is achieved when triethanolamine is mixed in.

Also, KOH has good reactivity and may itself deteriorate from carbon when supplied together with fuel, or may promote the deterioration of the materials of the anion exchange membrane and catalyst electrodes and the like depending on those materials. Triethanolamine, on the other hand, has poor reactivity compared with KOH. Therefore, using triethanolamine enables the durability of the fuel cell to be improved.

Moreover, another substance with an ion-conducting property may be used as the conduction-assisting agent instead of triethanolamine. More specifically, for example, any of the following may be used: triethylenediamine (C₄H₁₂N₁₂) given in Chemical formula 2 below, tetraethylenediamine (C₄H₁₂N₂) given in Chemical formula 3 below, and an imidazolium compound such as that given in Chemical formula 4 and Chemical formula 5 below. Incidentally, similar to triethanolamine, these can be used as an anion exchange group in the anion exchange membrane.

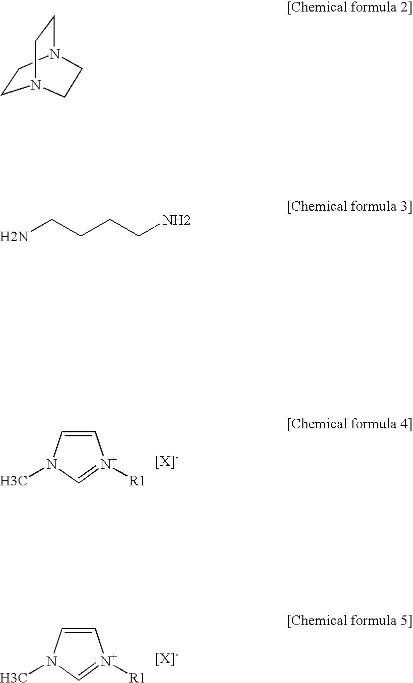

As described above, using the conduction-assisting agent that is used as the anion exchange group for the electrolyte improves the durability of the fuel cell, as well as improves the output effect of the fuel cell because it assists in the formation of a proper three-phase boundary.

In the foregoing example embodiments, various numbers are referred to with respect to the number of elements, quantities, amounts, ranges and the like. However, the invention is not limited to those numbers. Also, the invention is also not limited to the structure and method steps and the like described in the foregoing example embodiments.

1. An alkaline fuel cell comprising:
an electrolyte;
an anode provided on one side of the electrolyte and a cathode provided on the other side of the electrolyte; and
a fuel passage which is formed so as to contact the anode and through which fuel flows,
wherein potassium hydroxide is mixed in with the fuel.

2. (canceled)

3. The alkaline fuel cell according to claim 1, wherein the electrolyte includes an electrolyte solution that conducts anions.

4. The alkaline fuel cell according to claim 1, wherein the electrolyte is an anion exchange membrane.

5.-6. (canceled)

7. The alkaline fuel cell according to claim 3, wherein the fuel is one selected from among the group consisting of alcohol, methane, ammonium, and hydrogen.

8. The alkaline fuel cell according to claim 7, wherein the fuel is one selected from among the group consisting of methanol and ethanol.

9. The alkaline fuel cell according to claim 8, wherein if the fuel is methanol, a concentration of methanol aqueous solution is 5 to 20 percent by weight.

10. The alkaline fuel cell according claim 1, wherein a percent of the potassium hydroxide with respect to the fuel is greater than 0 and equal to or less than 20%.

11. An alkaline fuel cell system that uses the alkaline fuel cell according to claim 1, comprising:
a fuel supply apparatus that supplies fuel to the fuel passage; and
an ion-conducting substance supply apparatus that supplies the potassium hydroxide together with the fuel.

12. The alkaline fuel cell system according to claim 11, further comprising:
a circulation passage that circulates unreacted fuel that is discharged from the anode back to the fuel passage,
wherein the circulation passage connects a downstream side of the fuel passage where unreacted fuel is discharged from the anode with an upstream side of the fuel passage.

13. The fuel cell system according to claim 12, wherein when unreacted fuel is circulated to the fuel passage by the circulation passage, the ion-conducting substance supply apparatus supplies the potassium hydroxide to the fuel passage at a predetermined timing.
